(19) United States
(12) Patent Application Publication
(10) Pub. No.: US 2006/0156391 A1
(43) Pub. Date: Jul. 13, 2006

(54) Method and apparatus providing policy-based revocation of network security credentials

(76) Inventor: Joseph Salowey, Seattle, WA (US)

Correspondence Address: HICKMAN PALERMO TRUONG & BECKER, LLP, 2055 GATEWAY PLACE, SUITE 550, SAN JOSE, CA, 95110, US

(21) Appl. No.: 11/034,346

(22) Filed: Jan. 11, 2005

(51) Int. Cl. H04L 9/32; H04L 9/00; G06K 9/00; G06F 17/30; G06F 15/16; G06F 7/04; G06F 7/58; G06K 19/00

(52) U.S. Cl. 726/5; 713/158

(57) ABSTRACT

A method for policy-based revocation of network security credentials comprises receiving and storing one or more credential revocation rules, wherein each of the credential revocation rules specifies one or more first attributes and first values of the first attributes, associated with one or more credentials to be revoked; receiving and storing one or more network credentials, wherein each of the network credentials comprises one or more second attributes and second values of the second attributes; and when second values of one or more second attributes of a particular network credential among the one or more network credentials match first values of one or more first attributes of one of the credential revocation rules, determining that the particular network credential is invalid, and performing a responsive action.

### FIELD OF THE INVENTION

The present invention generally relates to security in computer networks. The invention relates more specifically to techniques for revoking security credentials such as digital certificates, passwords, etc.

### BACKGROUND

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

Many computer network security systems involve distributing credentials or state information from an authority element to network elements in the system. If the state information changes, or the credentials become invalid, then the authority element may elect to revoke the credentials or state information, and the authority element needs to inform the network elements that revocation has occurred.

In one past approach, a certificate authority (CA) distributes digital certificates to routers, switches, or other elements in a packet-switched network. The CA maintains a certificate revocation list (CRL) that lists information identifying all certificates that the CA has revoked or declared invalid. The CRL identifies each revoked certificate by a unique identifier value. Each network element may periodically contact the CA and download the current CRL. Depending on whether a particular digital certificate is found in the CRL, the network element either validates or cannot validate the particular certificate. Alternatively, an online service is consulted each time that a network element needs to validate a certificate; an example is OSCP. In an offline model in which a CRL is periodically downloaded, the size of the CRL becomes critical due to network bandwidth, traffic or other constraints.

However, using this approach, if an event occurs that invalidates a large number of certificates or other credentials, revoking all the credentials is difficult and time-consuming. For example, assume that a managed network includes 1,000 routers, each of which is running an operating system of version “3.0,” and each router stores a digital attribute certificate. Assume further that for security reasons, a particular server will provide a particular service to one of the routers only if the requesting router presents an attribute certificate that shows a valid and trusted machine configuration. Assume still further that a vendor of the operating system determines that a critical bug is present in operating system version “3.0,” and this bug is sufficient to require the server to deny service to routers with that bug. To block service to the routers, then all 1,000 certificates need to be revoked. There is no easy or efficient way to do so in current practice. For example, the CA needs to store 1,000 entries in the CRL, which may be unreasonably large. If the CA is implemented in a router in the network, for example, the limited storage resources of a router place constraints on the allowable size of the CRL.

The preceding approach is used, for example, in the digital certificate techniques defined in ITU standard X.509, in IETF Request for Comments (RFC) 3281, and in the IETF PKIX technique of RFC 3280. Certificate authorities based on these protocols have been commercially implemented by Microsoft Corporation, Entrust, and Verisign.

Based on the foregoing, there is a clear need for improved techniques for revoking credentials in a computer network.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram of an example system providing policy-based revocation of network security credentials;

FIG. 2 is a block diagram of an example network element containing software elements that provide policy-based revocation of network security credentials;

FIG. 3 is a block diagram of an example revocation rule list;

FIG. 4 is a flow diagram that illustrates a high level overview of one embodiment of a method for policy-based revocation of network security credentials; and

FIG. 5 is a block diagram that illustrates a computer system upon which an embodiment may be implemented.

### DETAILED DESCRIPTION

A method and apparatus for policy-based revocation of network security credentials is described. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

The needs identified in the foregoing Background, and other needs and objects that will become apparent for the following description, are achieved in the present invention, which comprises, in one aspect, a method for policy-based revocation of network security credentials comprising: receiving and storing one or more credential revocation rules, wherein each of the credential revocation rules specifies one or more first attributes and first values of the first attributes, associated with one or more credentials to be revoked; receiving and storing one or more network credentials, wherein each of the network credentials comprises one or more second attributes and second values of the second attributes; and when second values of one or more second attributes of a particular network credential among the one or more network credentials match first values of one or more first attributes of one of the credential revocation rules, determining that the particular network credential is invalid, and performing a responsive action. The credentials may be generated and signed or otherwise authenticated by an authority; consumers of the credentials then can validate that the credentials were actually generated by the authority.

Further, a revocation authority may perform the steps of receiving information defining one or more of the credential revocation rules, and providing the credential revocation rules to one or more network elements. In one approach, the revocation authority performs: storing the credential revocation rules in a credential revocation rule list at a revocation authority; creating a network credential revocation message that contains one or more of the credential revocation rules; and sending the network credential revocation message to the network elements using a multicast message. In one variation, providing the credential revocation rules comprises storing the credential revocation rules in a server, wherein a network location of the server is identified in the particular network credential. Additionally or alternatively, the network credential revocation message is sent only to network elements that have previously received one or more credentials that potentially match the credential revocation rules in the message.

In other aspects, the invention encompasses a computer apparatus and a computer-readable medium configured to carry out the foregoing steps.

Embodiments are described herein according to the following outline:
1.0 Structural Overview
2.0 Functional Overview
3.0 Implementation Mechanisms-Hardware Overview
4.0 Extensions and Alternatives
   1.0 Structural Overview

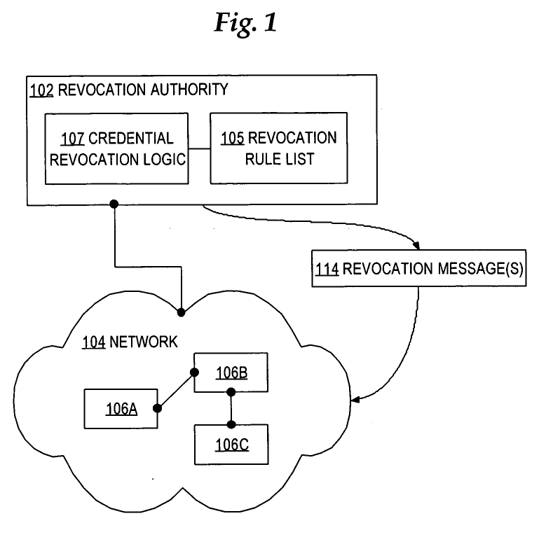

FIG. 1 is a block diagram of an example system providing policy-based revocation of network security credentials. A revocation authority 102 is communicatively coupled to a network 104 comprising one or more network elements 106A, 106B, 106C. Revocation authority 102 may be implemented, in various embodiments, as a network management station or system, a router for a packet-switched network, or any other suitable computing device that can communicate with a network and perform the revocation authority functions described herein. Revocation authority 102 may be, but need not be, integrated with a certificate authority.

In the example of FIG. 1, network 104 is a packet-switched network and each of the network elements 106A, 106B, 106C is a router, switch, or other infrastructure element. Alternatively, any or all of network elements 106A, 106B, 106C may comprise end station devices, wireless devices, etc. The techniques herein can also form a part of network security solutions that involve a combination of multiple servers and software that interact to provide comprehensive network security including access, authorization and accounting (AAA) services, user admission control, etc. For example, the techniques herein can be used to perform posture validation of a first network element that presents an attribute certificate to a second network element. As a specific example, this technique can be used to revoke credentials that are issued to a network element based on the posture of the network element, when an event invalidates the criteria for which the posture was evaluated.

For purposes of illustrating a clear example, FIG. 1 shows three (3) such network elements, but in other embodiments there may be any number of network elements. This disclosure specifically contemplates embodiments for use with networks having thousands or network elements.

Revocation authority 102 maintains a revocation rule list 105. Revocation authority 102 hosts credential revocation logic 107, which comprises one or more sequences of computer program instructions or other software elements that implement the revocation authority functions described further herein. In performing these functions, revocation authority 102 may send one or more revocation messages 114 to network 104 and network elements 106A, 106B, 106C. Revocation authority 102 also may perform network routing or other functions in addition to the credential revocation methods described herein; that is, the techniques herein do not require dedicating the revocation authority only to perform revocation.

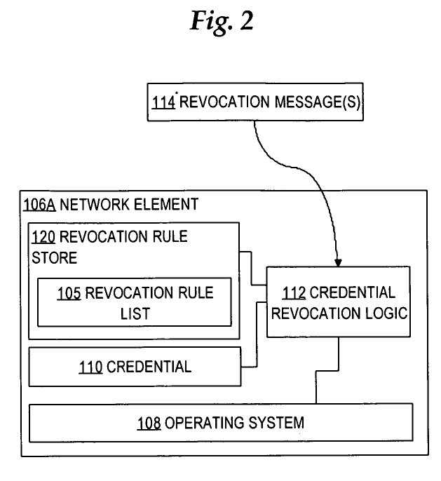

FIG. 2 is a block diagram of an example network element containing software elements that provide policy-based revocation of network security credentials. For example, each of the network elements 106A, 106B, 106C of FIG. 1 may have the constituent elements shown in FIG. 2. A network element 106A may comprise an operating system 108 that hosts credential revocation logic 112, which receives and evaluates one or more credentials 110, and stores a revocation rule list 105 in a revocation rule store 120. The credentials 110 may include certificate authority root keys, digital certificates, passwords, or any other information that the revocation authority 102 may need to revoke. In one embodiment, credential 110 is an attribute certificate conforming to RFC 3281. The revocation rule store 120 may be structured as a cache in memory, a MIB, or any other suitable data structure or data store.

The credential revocation logic 112 may receive and process one or more revocation messages 114 that revocation authority 102 issues. The credential revocation logic 112 comprises one or more sequences of computer program instructions or other software elements that implement the network element functions described further herein. In one embodiment, credential revocation logic 112 may be implemented as part of Cisco IOS® Software, from Cisco Systems, Inc., San Jose, Calif., either as an application that runs under control of IOS or integrated into IOS.

According to one embodiment, to revoke one or more credentials, revocation authority 102 sends or propagates revocation messages 114 to network 104. Each revocation message 114 defines a revocation policy or rule. Further, the revocation rule list 105 stores revocation policies or rules that can be placed in revocation messages 114. A network element that receives the revocation messages 114 extracts the revocation rules carried in the message and stores the rules in a local revocation rule list 105 in revocation rule store 120.

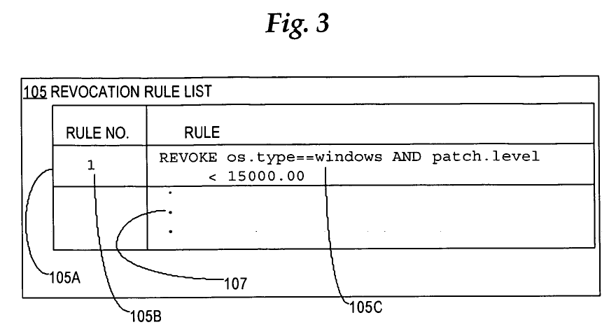

FIG. 3 is a block diagram of an example revocation rule list. A revocation rule list 105 may comprise one or more revocation rules 105A, each comprising a rule identifier 105B and a rule statement 105C. Each credential 110 stored in a network element 106A, 106B, 106C has one or more attribute-value pairs. The values are for attributes of the network element. For example, attributes can be a role played by the network element, location of the network element, software version information, hardware type or version information, etc. Thus, credential 110 may comprise an attribute credential or authorization credential, as opposed to an identity credential. A network element uses an identity credential to prove its identity to another element, and a network element uses an attribute credential to prove its attributes to another element for purposes of obtaining authorization to perform acts or access resources. For example, a credential authority may issue an attribute credential to a network element to certify the current configuration and software of the network element. The credential authority may be hosted at the same network element that hosts the revocation authority 102, or at a different network element.

Each rule statement 105C specifies one or more attribute-value pairs. For example, a rule statement 105C may express the rule “REVOKE os.type=windows AND patch.level<15000.00.” This example rule means that the revocation authority 102 is revoking all credentials 110 that have an “os.type” attribute equal to “windows” and a “patch.level” attribute with a value less than “15000.00.” As another example, a rule may express a policy that all attribute certificates issued before a certain date for devices with a particular hardware type are revoked. Rule statements 105C may express any number of attribute-value pairs, linked using Boolean logical operators such as AND, OR, etc. Relationships of attributes and values may use arithmetic operators indicating equality, greater than, less than, or other arithmetic relationships.

As indicated by ellipsis 107, a revocation rule list 105 may comprise any number of revocation rules 105A. Revocation rule list 105 may be stored as a list of attribute-value pairs, a table in a management information base (MIB) of a device that uses SNMP, or any other data structure or data storage repository. The specific method of representing rule statements 105C is not critical, and the symbolic text shown in FIG. 3 is given as just one example of forming a rule statement.

2.0 Functional Overview

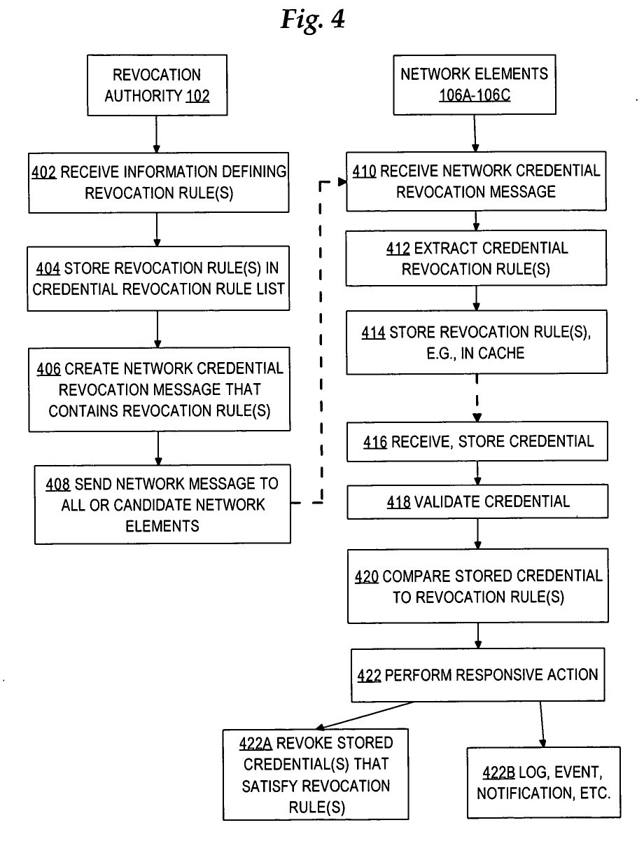

FIG. 4 is a flow diagram that illustrates a high level overview of one embodiment of a method for policy-based revocation of network security credentials.

At step 402, revocation authority 102 receives information defining one or more revocation rules, and the rules are stored in a revocation rule list at step 404. For example, steps 402-404 may involve a user providing input to a graphical user interface tool that facilitates defining attribute-value pairs or other characteristics of revocation rules and storing the revocation rules in revocation rule list 105 of revocation authority 102. Alternatively, steps 402-404 may involve a user issuing a command-line interface (CLI) command that defines a revocation rule and commands revocation authority 102 to store the revocation rule in the revocation rule list.

In another alternative, steps 402-404 may involve revocation authority 102 receiving revocation rules through programmatic means, such as by receiving an event, a method call from an external program or system. In yet another alternative, steps 402-404 may involve revocation authority 102 receiving rule information through a bulk data transfer method such as a file transfer protocol (FTP) transaction, an SNMP bulk SET operation, etc. Thus, the particular method used at step 402-404 to provide revocation rules to revocation authority is not critical, and steps 402-404 may use any other method or technology now known or invented hereafter.

As still another alternative, step 402 may involve receiving revocation rules that are generated automatically in response to a network threat announcement. For example, revocation authority 102, or another element involved in monitoring network threats, might receive information indicating that a certain version or patch of a particular operating system has a security vulnerability. In response, revocation authority 102 could create a revocation rule that revokes all certificates with attribute values that matching that operating system version or patch.

In steps 406-408, revocation authority 102 provides one or more revocation rules to network elements. At step 406, revocation authority 102 creates a network credential revocation message that contains one or more revocation rules, such as revocation message 114 of FIG. 1, FIG. 2. To protect against forgery, spoofing, or man-in-the-middle attacks, revocation authority 102 may digitally sign the credential revocation message at step 406 using a public key signing approach. Alternatively, step 406 can involve encrypting the credential revocation message 114 using a symmetric key that the revocation authority has pre-shared or otherwise provided to the receiving network elements.

At step 408, revocation authority 102 sends the network message to network elements at step 408. The credential revocation message may adhere to any suitable network message protocol. In one approach, step 408 may involve sending the revocation message to all network elements 106A, 106B, 106C in network 104. Step 408 can involve using a broadcast or multicast messaging protocol, an event bus, or other mechanisms for communicating one message to multiple receivers.

Alternatively, step 408 may involve storing a revocation message in a designated location, such as at a Web server or FTP server, that the network elements 106A, 106B, 106C access. With this alternative, the revocation information can be provided in a high-availability configuration, so that even if revocation authority 102 fails, the revocation policies or rules remain available to network elements that need them. In addition, if revocation authority 102 needs to deliver a large amount of revocation policies or rules, storing the revocation rules at a Web server or FTP server results in propagating the rules rapidly throughout the network. Rapid propagation occurs because the revocation authority is not required to use multicast or other methods to deliver the same information to a large number of devices.

Alternatively, step 408 may involve determining a subset or candidate list from all network elements in the network 104, and sending the revocation message 114 only to the candidate network elements. For example, revocation authority 102 can maintain information about what network elements are likely to need the revocation message 114, based on attributes of the credentials 110 at those network elements. Revocation authority 102 then can send the revocation message 114 only to the network elements that need the revocation message or are expected to have interest in the revocation message.

In one embodiment, steps 406-408 are periodically performed according to a schedule. For example, revocation authority 102 may issue one or more credential revocation messages every six to eight hours. The schedule may encompass any desired delivery timing.

Steps 406-408, may be implemented in any of three modes. In one mode, a revocation authority propagates or “pushes” revocation information into the network. In other implementations the approaches described herein also may be applied in an online revocation mode in which a service is consulted for every transaction that requires consulting a CRL, or in a pull mechanism in which devices periodically download CRLs or other credentials.

Steps 410-422 of FIG. 4 are performed by each of the network elements 106A-106C that receives the credential revocation message that the revocation authority 102 sent at step 408. A network element 106A-106C may perform steps 410-422 using credential revocation logic 112. Thus, for example, at step 410, a particular network element 106A receives the credential revocation message 114. At step 412, the network element extracts one or more credential revocation rules from the revocation message. At step 414, the network element stores the revocation rules, for example, in a revocation rule cache or other data store.

At some point in time after step 414, which may be immediate or after a long time, the network element receives and stores a credential, as shown by step 416. For example, network element 106A may receive a digital certificate from another network element that wishes to interact with network element 106A and may store the digital certificate as credential 110 in revocation rule store 120. Network element 106A may receive credential 110 from the same network element that is serving as revocation authority 102, or from a different network element or source.

In one embodiment, step 416 may also involve polling or accessing a Web server or FTP server that contains credential revocation rules. For example, a digital certificate received at step 416 may contain a URL or other network location identifier that identifies a server location in the network that stores revocation rules potentially applicable to the certificate. In response, the network element 106A contacts the server and retrieves one or more credential revocation messages or rules. This approach may be performed additionally or alternatively with respect to steps 410-412.

In step 418, the network element validates the received credential. Conventional credential validation techniques may be used. For example, when the credential 110 is a digital certificate that has been digitally signed by a certificate authority, public key cryptography approaches may be used to determine whether the digital signature is correct.

If the credential is validated successfully, then in step 420, the network element compares attributes of the credential to the stored revocation rules. For example, credential revocation logic 112 compares each attribute defined in each revocation rule and determines whether the received credential 110 has that attribute. If so, credential revocation logic 112 compares each value in the revocation rule associated with that rule and determines if the corresponding value in the credential 110 satisfies the arithmetic operator or other criteria in the revocation rule.

If all attribute-value pairs in a revocation rule match attributes and values in the credential 110 according to the operators in the revocation rule, then a responsive action is taken, as shown by step 422. Responsive action at step 422 may include invalidating the credential, as shown at step 422A. Invalidating the credential typically involves marking the credential as invalid or deleting the credential from storage. Additionally or alternatively, as shown by step 422B, if a rule match occurs then step 422 may involve writing a log entry indicating identification of a non-compliant or revoked credential, issuing an alert message or other notification, publishing an event using an event bus, or taking other responsive action. Responsive action at step 422 also can include refusing access to services or resources.

Steps 410-414 may involve essentially caching all received revocation rules at the network element, and steps 416-422 may involve applying the cached revocation rules to received credentials after a specified period. Alternatively, a network element may apply revocation rules immediately to all previously received credentials. Thus, a process of caching, followed by a time delay, followed by applying revocation rules, is not required.

Using this approach, a revocation authority can broadcast a revocation policy, expressed in a revocation rule, to some or all network elements in a network that have potentially matching credentials. Logic in the network elements determines whether any of several existing credentials, or credentials received later, match the revocation rule. In this way, a revocation authority can efficiently cause revocation of large numbers of credentials. Further, a single message expressing a broadly framed policy or rule can result in revocation of groups of credentials at many network elements. In one approach, a network element that has a stored cache of credentials for itself, for existing sessions, and/or for other elements can use the revocation policy information to invalidate entries in the cache. In another approach, a network element that has received a credential from another entity, which is requesting access to a service or resource protected by the network element, can check the credential against the revocation policy information. The revocation policies or rules can be stored in a cache or any other appropriate data store in the network element.

Thus, the approaches herein offer an improvement over prior technology because the revocation authority stores less data, since a single revocation policy or rule can encompass a large number of individual credentials. A revocation rule list 105 covering thousands of credentials can occupy far less data storage than a conventional CRL that individually identifies the thousands of credentials. The revocation authority is not required to track certificates or other credentials, issued by the revocation authority or a separate certificate authority, individually. Further, sending a broadcast or multicast message as described herein is far more efficient than prior practice, in which each network element must check whether a digital certificate is in a CRL maintained at a CA. Moreover, sending a single revocation message can cause many credentials located throughout a network to become invalid.

For example, assume that a network includes a certification service that issues certificates based on the correctness of an entity's configuration and whether its software is current. The entity then can present the certificate to another entity that wants to know the status of the first entity's configuration. The certificate could contain attributes indicating host characteristics, such as an operating system version number. For example, assume that a certificate contains the attribute Operating-System-Version=12.2.1. If version 12.2.1 of the operating system is found to have a software bug that made it insecure, then all of the certificates that have issued based on that version can be revoked with one message using the techniques herein.

While the techniques described herein have been described in the context of attribute credentials, the techniques are also applicable to identity certificates that are structured with attributes that can be matched against revocation rules. For example, an identity certificate that has attributes identifying a user location, user role, etc., then rules can be structured to match values of those attributes.

The techniques described herein can be used as part of any larger technology solution or business solution in which an attribute-based credential is used to authorize access. Although the approaches described above are explained in the context of network elements, the techniques described herein also can be used among applications. For example, the techniques herein could be used by web services applications that use attribute certificates or signed attribute assertions as a basis for authorizing access to resources.

3.0 Implementation Mechanisms—Hardware Overview

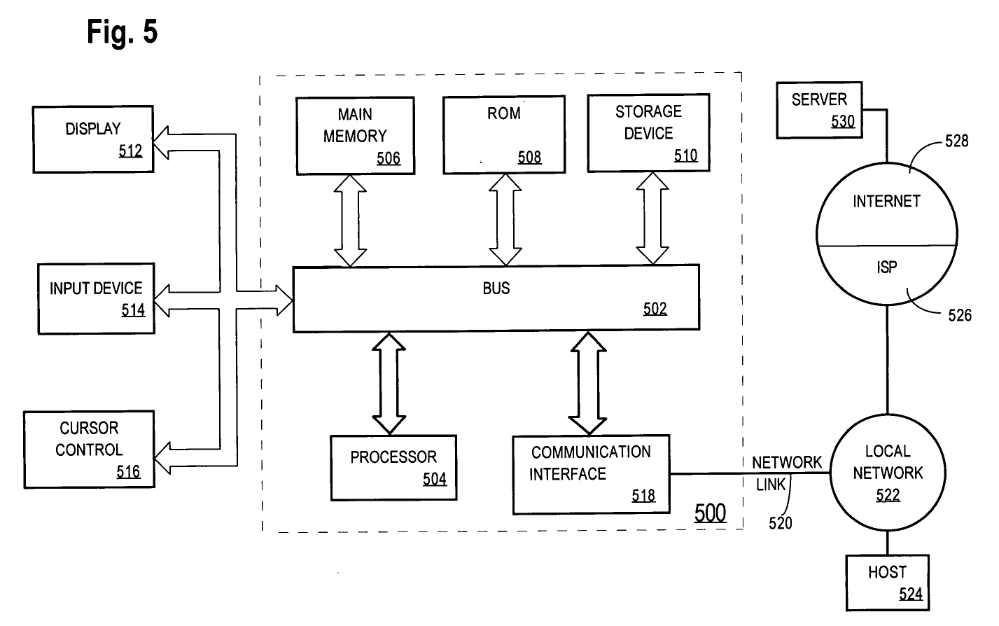

FIG. 5 is a block diagram that illustrates a computer system 500 upon which an embodiment of the invention may be implemented. The preferred embodiment is implemented using one or more computer programs running on a network element such as a router device. Thus, in this embodiment, the computer system 500 is a router.

Computer system 500 includes a bus 502 or other communication mechanism for communicating information, and a processor 504 coupled with bus 502 for processing information. Computer system 500 also includes a main memory 506, such as a random access memory (RAM), flash memory, or other dynamic storage device, coupled to bus 502 for storing information and instructions to be executed by processor 504. Main memory 506 also may be used for storing temporary variables or other intermediate information during execution of instructions to be executed by processor 504. Computer system 500 further includes a read only memory (ROM) 508 or other static storage device coupled to bus 502 for storing static information and instructions for processor 504. A storage device 510, such as a magnetic disk, flash memory or optical disk, is provided and coupled to bus 502 for storing information and instructions.

A communication interface 518 may be coupled to bus 502 for communicating information and command selections to processor 504. Interface 518 is a conventional serial interface such as an RS-232 or RS-422 interface. An external terminal 512 or other computer system connects to the computer system 500 and provides commands to it using the interface 514. Firmware or software running in the computer system 500 provides a terminal interface or character-based command interface so that external commands can be given to the computer system.

A switching system 516 is coupled to bus 502 and has an input interface 514 and an output interface 519 to one or more external network elements. The external network elements may include a local network 522 coupled to one or more hosts 524, or a global network such as Internet 528 having one or more servers 530. The switching system 516 switches information traffic arriving on input interface 514 to output interface 519 according to pre-determined protocols and conventions that are well known. For example, switching system 516, in cooperation with processor 504, can determine a destination of a packet of data arriving on input interface 514 and send it to the correct destination using output interface 519. The destinations may include host 524, server 530, other end stations, or other routing and switching devices in local network 522 or Internet 528.

The invention is related to the use of computer system 500 for policy-based revocation of network security credentials. According to one embodiment of the invention, policy-based revocation of network security credentials is provided by computer system 500 in response to processor 504 executing one or more sequences of one or more instructions contained in main memory 506. Such instructions may be read into main memory 506 from another computer-readable medium, such as storage device 510. Execution of the sequences of instructions contained in main memory 506 causes processor 504 to perform the process steps described herein. One or more processors in a multi-processing arrangement may also be employed to execute the sequences of instructions contained in main memory 506. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 504 for execution. Such a medium may take many forms, including but not limited to, non-volatile media, volatile media, and transmission media. Non-volatile media includes, for example, optical or magnetic disks, such as storage device 510. Volatile media includes dynamic memory, such as main memory 506. Transmission media includes coaxial cables, copper wire and fiber optics, including the wires that comprise bus 502. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 504 for execution. For example, the instructions may initially be carried on a magnetic disk of a remote computer. The remote computer can load the instructions into its dynamic memory and send the instructions over a telephone line using a modem. A modem local to computer system 500 can receive the data on the telephone line and use an infrared transmitter to convert the data to an infrared signal. An infrared detector coupled to bus 502 can receive the data carried in the infrared signal and place the data on bus 502. Bus 502 carries the data to main memory 506, from which processor 504 retrieves and executes the instructions. The instructions received by main memory 506 may optionally be stored on storage device 510 either before or after execution by processor 504.

Communication interface 518 also provides a two-way data communication coupling to a network link 520 that is connected to a local network 522. For example, communication interface 518 may be an integrated services digital network (ISDN) card or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the worldwide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are exemplary forms of carrier waves transporting the information.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518. In accordance with the invention, one such downloaded application provides for policy-based revocation of network security credentials as described herein.

The received code may be executed by processor 504 as it is received, and/or stored in storage device 510, or other non-volatile storage for later execution. In this manner, computer system 500 may obtain application code in the form of a carrier wave.

4.0 Extensions and Alternatives

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method, comprising the computer-implemented steps of:
receiving one or more credential revocation rules, wherein each of the credential revocation rules specifies one or more first attributes and first values of the first attributes, associated with one or more credentials to be revoked;
receiving one or more network credentials, wherein each of the network credentials comprises one or more second attributes and second values of the second attributes; and
when second values of one or more second attributes of a particular network credential among the one or more network credentials match first values of one or more first attributes of one of the credential revocation rules, determining that the particular network credential is invalid, and performing a responsive action.

2. A method as recited in claim 1, wherein the one or more network credentials are attribute certificates.

3. A method as recited in claim 1, wherein one or more network credentials are identity certificates.

4. A method as recited in claim 1, wherein the one or more credential revocation rules are stored in a revocation rule cache.

5. A method as recited in claim 1, further comprising retrieving one or more additional credential revocation rules in response to receiving and storing the one or more network credentials.

6. A method as recited in claim 1, wherein the responsive action comprises any of invalidating the credential, writing a log entry indicating identification of a non-compliant or revoked credential, issuing an alert message or other notification, publishing an event using an event bus, and refusing access to services or resources.

7. A method as recited in claim 1, further comprising periodically downloading the network credentials and storing the downloaded network credentials.

8. A method as recited in claim 1, wherein requesting the network credentials comprises requesting an online credential service to provide the network credentials for verification as part of a particular online transaction.

9. A method as recited in claim 1, further comprising:
receiving information defining one or more of the credential revocation rules;
providing the credential revocation rules to one or more network elements.

10. A method as recited in claim 9, further comprising:
storing the credential revocation rules in a credential revocation rule list at a revocation authority;
creating a network credential revocation message that contains one or more of the credential revocation rules; and
sending the network credential revocation message to the network elements using a multicast message.

11. A method as recited in claim 9, wherein providing the credential revocation rules comprises storing the credential revocation rules in a server, wherein a network location of the server is identified in the particular network credential.

12. A method as recited in claim 10, wherein the network credential revocation message is sent only to network elements that have previously received one or more credentials that potentially match the credential revocation rules in the message.

13. A method as recited in claim 1, wherein the steps are performed by a router in a packet-switched network that is communicatively coupled to a revocation authority.

14. A computer-readable medium carrying one or more sequences of instructions for policy-based revocation of network security credentials, which instructions, when executed by one or more processors, cause the one or more processors to carry out the steps recited in and characterized by the features of any of claims 1, 2, 3, 4, 5, 6, 7, 8, 9, 10, 11, 12, or 13.

15. An apparatus for policy-based revocation of network security credentials, comprising:
means for receiving and storing one or more credential revocation rules, wherein each of the credential revocation rules specifies one or more first attributes and first values of the first attributes, associated with one or more credentials to be revoked;
means for receiving and storing one or more network credentials, wherein each of the network credentials comprises one or more second attributes and second values of the second attributes; and
means for determining, when second values of one or more second attributes of a particular network credential among the one or more network credentials match first values of one or more first attributes of one of the credential revocation rules, that the particular network credential is invalid, and performing a responsive action.

16. An apparatus as recited in claim 15, further comprising means for performing the steps and comprising the features of any of claims 2, 3, 4, 5, 9, 10, 11, 12, or 13.

17. An apparatus for policy-based revocation of network security credentials, comprising:
a network interface that is coupled to the data network for receiving one or more packet flows therefrom;
a processor;
one or more stored sequences of instructions which, when executed by the processor, cause the processor to carry out the steps of the steps of any of claims 1, 2, 3, 4, 5, 9, 10, 11, 12, or 13.

18. A network security system, comprising:
a revocation authority configured with first logic that generates one or more credential revocation rules, wherein each of the credential revocation rules specifies one or more first attributes and first values of the first attributes, associated with one or more credentials to be revoked, wherein the revocation authority is communicatively coupled to a network;
one or more network elements that are communicatively coupled to the network and comprising second logic, wherein the second logic causes the network elements to perform the steps of:
receiving and storing one or more of the credential revocation rules;
receiving and storing one or more network credentials, wherein each of the network credentials comprises one or more second attributes and second values of the second attributes; and
when second values of one or more second attributes of a particular network credential among the one or more network credentials match first values of one or more first attributes of one of the credential revocation rules, determining that the particular network credential is invalid, and performing a responsive action.

19. A system as recited in claim 18, wherein the one or more network credentials are attribute certificates.

20. A system as recited in claim 18, wherein one or more network credentials are identity certificates.

21. A system as recited in claim 18, wherein the one or more credential revocation rules are stored in a revocation rule cache.

22. A system as recited in claim 18, further comprising retrieving one or more additional credential revocation rules in response to receiving and storing the one or more network credentials.

23. A system as recited in claim 18, wherein the first logic enables the revocation authority to receive information defining one or more of the credential revocation rules and provide the credential revocation rules to one or more network elements.

24. A system as recited in claim 23, wherein the first logic further comprises one or more sequences of instructions for storing the credential revocation rules in a credential revocation rule list at the revocation authority; creating a network credential revocation message that contains one or more of the credential revocation rules; and sending the network credential revocation message to the network elements using a multicast message.

25. A system as recited in claim 23, wherein providing the credential revocation rules comprises storing the credential revocation rules in a server logically separate from the revocation authority, wherein a network location of the server is identified in the particular network credential.

26. A system as recited in claim 24, wherein the network credential revocation message is sent only to network elements that have previously received one or more credentials that potentially match the credential revocation rules in the message.

27. A system as recited in claim 18, wherein the steps of the second logic are performed by a router in the packet-switched network that is communicatively coupled to the revocation authority.

28. A method as recited in claim 1, wherein the one or more network credentials include a digital signature that has been applied by a certificate authority, and further comprising the step of verifying the digital signature as part of receiving and storing the credentials.
